(19) United States
(12) Patent Application Publication
(10) Pub. No.: US 2005/0280815 A1
(43) Pub. Date: Dec. 22, 2005

(54) Method and apparatus for providing an integrating sphere

(76) Inventors: Alan Ingleson, Newbury (GB); David Slocum, Yardley, PA (US); Joseph Reed, Somerset, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 11/050,408

(22) Filed: Feb. 3, 2005

Related U.S. Application Data
(60) Provisional application No. 60/541,854, filed on Feb. 3, 2004.

(51) Int. Cl. G01J 3/40

(52) U.S. Cl. 356/304

(57) ABSTRACT

A method and apparatus for providing an integrating sphere for use as a measuring device is described. More specifically, the integrating sphere includes a generally spherical shell and a liner disposed within said generally spherical shell, wherein the liner is composed of a sintered polymer. In one embodiment, the liner is made up of a pre-formed polytetrafluoroethylene (PTFE) shell.

### CROSS-REFERENCE TO RELATED APPLICATIONS

This application is claims benefit of U.S. Provisional Patent Application Ser. No. 60/541,854, filed Feb. 3, 2004, which is incorporated by reference herein in its entirety.

### BACKGROUND OF THE INVENTION

1. Field of the Invention

The present invention generally relates to a spectrophotometer that is based on an integrating sphere. More particularly, the present invention relates to a method and apparatus for providing a spectrophotometer comprising an integrating sphere, where a generally spherical lining of a polymer (e.g., polytetrafluoroethylene (PTFE)) is inserted into an articulated shell enclosure that has a substantially spherical interior shape.

2. Description of the Related Art

A spectrophotometer utilizing an integrating sphere is an expensive device whose effectiveness depends on maintaining the highest possible reflectivity on the inside surface of the integrating sphere. Higher reflectivity throughout the visible spectrum enables the integrating sphere to operate more efficiently. Typically, a powder of fluorinated polymer can be sprayed on the inside surface of an existing integrating sphere in order to achieve a particular degree of reflectivity. However, the environment for the spraying requires considerably high temperatures. Moreover, it is also difficult to accumulate a sufficient amount of powder for the requisite opacity for a highly reflective surface.

Thus, there is a need in the art for a method and apparatus for providing an effective and an inexpensive integrating sphere for spectrophotometry.

### SUMMARY OF THE INVENTION

In one embodiment, a method and apparatus for providing an integrating sphere for use as a measuring device is described. More specifically, the integrating sphere includes a generally spherical shell and a liner disposed within said generally spherical shell, wherein the liner is composed of a sintered polymer. In another embodiment, the liner is made up of a pre-formed polytetrafluoroethylene (PTFE) shell.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a cross-sectional view of the front portion of the liner of the present invention;

FIG. 2 depicts a side view of the front portion of the liner of the present invention;

FIG. 3 depicts a bottom view of the front portion of the liner of the present invention;

FIG. 4 depicts a cross-sectional view of the rear portion of the liner of the present invention;

FIG. 5 depicts a cross-sectional top view of a rear portion half of the liner of the present invention;

FIG. 6 depicts a side view of the rear portion of the liner of the present invention; and

FIG. 7 depicts a side view of the integrating sphere within a spectrophotometer.

To facilitate understanding, identical reference numerals have been used, wherever possible, to designate identical elements that are common to the figures.

### DETAILED DESCRIPTION OF THE INVENTION

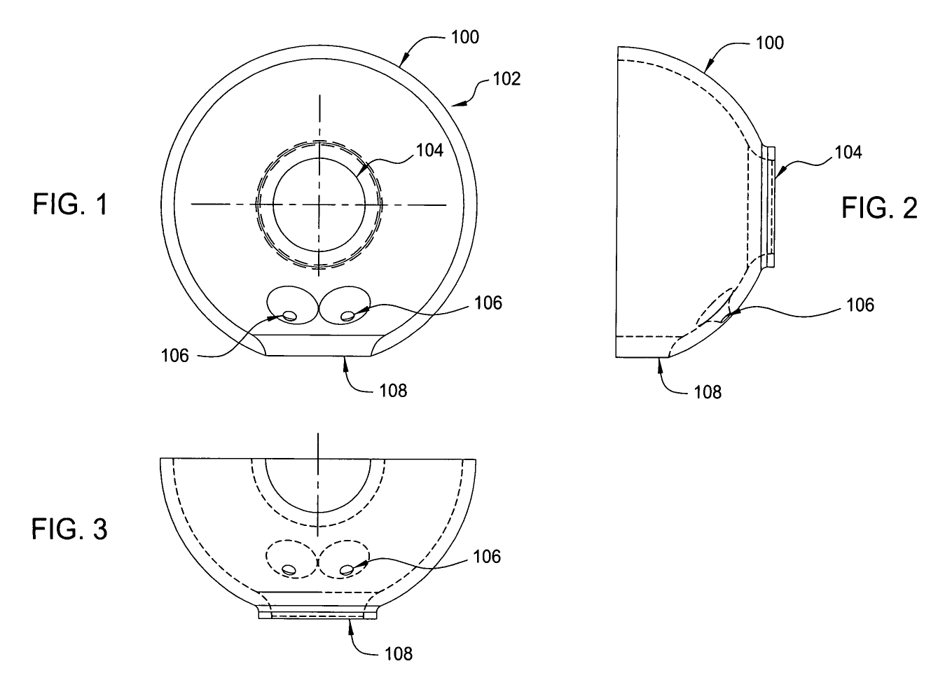

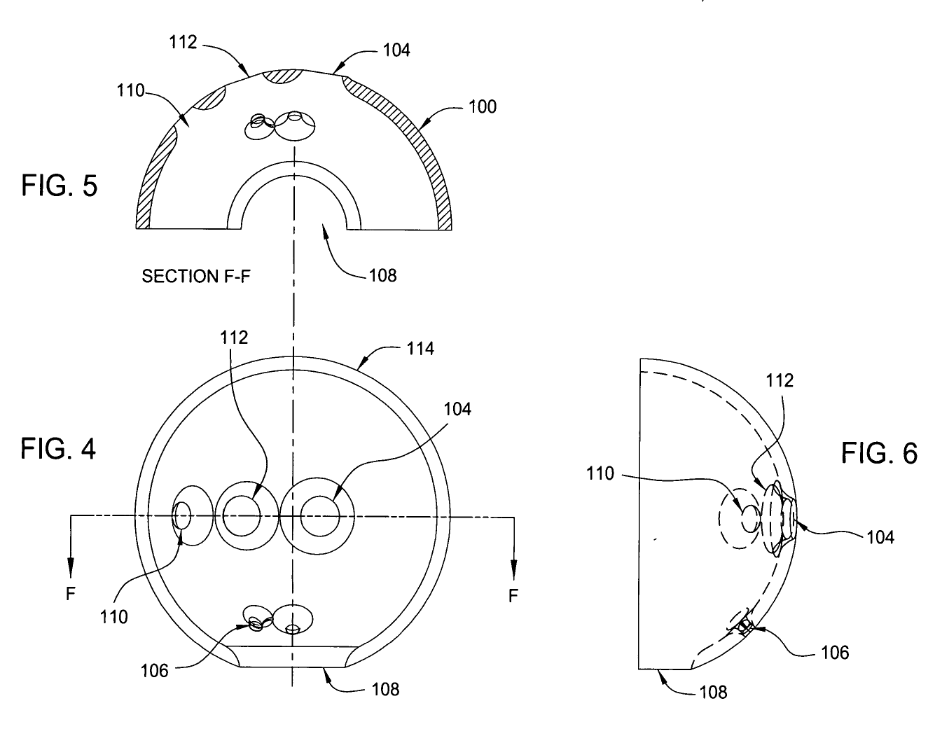

In one embodiment, the present invention comprises the insertion of a polytetrafluoroethylene (PTFE) spherical liner 100 inside an articulated spherical shell of an integrating sphere, which is a component of a spectrophotometer. This liner 100 may be manufactured in several manners, but is typically produced by a process involving either molding or sintering (e.g., forming a coherent mass by heating without melting) the PTFE material into pre-formed, hemispherical liner portions as shown in FIGS. 1 and 4. In one embodiment, the internal diameter of the integrating sphere (i.e., the greatest free air distance between the two hemispherical liners) should measure 152 millimeters in order to conform to industry standard. Correspondingly, as the diameter of the integrating sphere increases, the uniformity of illumination of the sample increases, but the efficiency of the integrating sphere decreases.

One example of fabricating the hemispherical liner portions involves filling stainless steel spherical molds with PTFE. The molds are each shaped to have an interior channel between an outer and inner wall. The PTFE is then filled within the interior channel with a predetermined width so that a hemispherical shell shaped liner with a respective thickness may be produced. The mold and PTFE are heated to a particular temperature where upon the PTFE is sintered. Similarly, the PTFE may also be further processed to reduce the porosity (e.g., to organic compounds) of the PTFE. Ultimately, front and rear portions of the liner 100, which are substantially hemispherical, are produced. The pre-formed integrity of the liner (compared to spraying a powder) ensures it can be inserted into an existing instrument with optimum opacity and reflectivity. In another embodiment, the PTFE is compacted into a hemispherical shell form to be employed in the integrating sphere.

FIGS. 1-3 depict different views of a first portion of the liner 100 of the present invention. The first portion 102 (e.g., a “front” hemisphere portion) may be compacted or preferably sintered into a generally hemispherical shell form. In one embodiment, the front portion 102 comprises a substantially hemispherical shape with a plurality of apertures. FIGS. 4-6 depict several views of a second portion of the liner 100. Similarly, the second portion 114 (e.g., a “rear” hemisphere portion) of the liner 100 may be compacted or preferably sintered into a generally hemispherical form. Collectively, the liner 100 includes apertures for a sample measurement channel, light entry, a reference channel, a specular channel, and the like.

The sample measurement channel aperture 104 is an opening located in both the front and rear portions of the liner 100. Typically, a sample substance is positioned in front of and abutted against the sample measurement channel aperture in order for the sample substance to be measured by the spectrophotometer. The light entry aperture 108 is the opening in the completed liner 100 where light enters the integrating sphere, which is necessary for the spectrophotometer to function.

The reference channel aperture 110 is the opening in the rear portion 114 of the liner 100. The reference channel aperture 110 is used to observe the integrating sphere's inner surface to determine how much light is in the sphere. The observation of the inner surface (i.e., the liner 100) may be conducted over the entire light spectrum. The specular channel aperture 112 is the opening in the rear portion 114 of the liner 100. The specular channel aperture 112 is used by the spectrophotometer to measure the specular component of the substance sample.

The front and rear portions of the liner 100 also include mounting positions 106 for at least one baffle. The baffles, which may be made up of PTFE, are static devices that impede the flow of light. Namely, these baffles prevent the entering light from directly shining on the substance sample and thus contributing toward the optimum diffusion of light within the sphere.

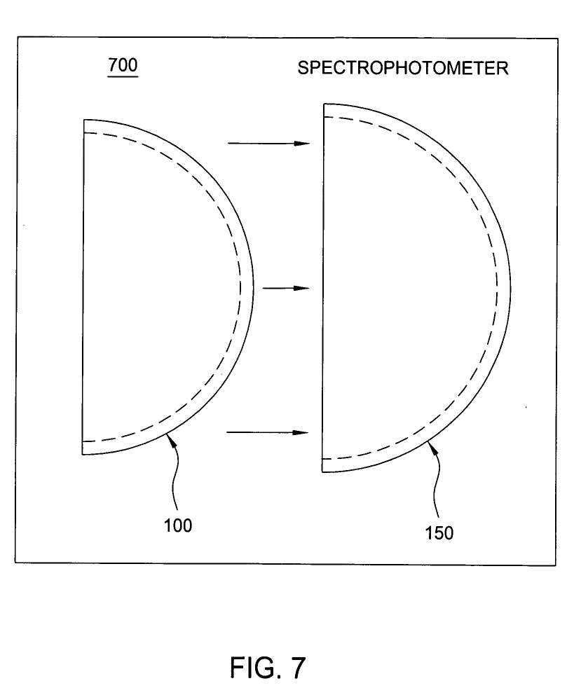

The manufactured liner 100 is then ultimately inserted into an outer articulated hemispherical shell 150 (i.e., a hemisphere of an integrating sphere) and attached into a set position. FIG. 7 demonstrates how one hemisphere of the liner 100 is positioned and joined to an outer hemispherical shell 150 of the integrating sphere within a spectrophotometer 700. Although FIG. 7 depicts a rudimentary spectrophotometer, those skilled in the art may be cognizant of the fact, associated modules and accessories are not shown. Any known method of adhering PTFE to a surface may be employed to join the liner 100 to the outer shell 150. For example, the liner 100 may rely on friction to hold itself in position after being placed into the outer articulated hemispherical shell 150. In another embodiment, the liner may be similarly placed in the outer shell 150 and affixed with pins for increased rotational stability (e.g., to prevent rotational slippage). In yet another embodiment, the liner 100 may be bound to the outer shell 150 with the aid of an adhesive substance, e.g., cyanoacrylate. Lastly, the two hemispherical portions of the liner 100 are adjoined when the two outer hemispherical shells (of the generally spherical outer shell) are united.

In order to improve the reflectivity of the liner 100, the PTFE may be manufactured with inclusions possessing refractive indexes that differ from the PTFE. For example, a homogenous mixture of PTFE with glass beads may be employed. However, the inner surface of the liner (i.e., liner/air interface) must only be PTFE to avoid specular reflections off the surface of the glass. In another embodiment, the inclusions may comprise barium sulfate. In the preferred embodiment, the present invention uses a layer of PTFE comprising bubble inclusions. These small bubble inclusions, which comprise of dispersed air bubbles that give the PTFE a white appearance, are homogenously distributed within the liner 100 for optimum reflectivity of the integrating sphere. Air bubbles are the preferred embodiment due to the considerable refractive index disparity between air and PTFE. Notably, the inclusions afford the necessary refractive-index discontinuities that ensure high reflectivity. Practical embodiments may have bubbles or other inclusions measuring from 5 to 20 microns in diameter. In one embodiment, the bubble inclusions average 10 microns in diameter.

The liner 100 of PTFE must also possess a particular thickness for effective performance. Notably, the liner 100 must be not be so thick as to occupy a significant volume of the integrating sphere, but thick enough so there is at most a 0.1 percent reflectance difference between the layer with a black backing and the layer with a white backing. Thus, the thickness of the liner will provide sufficient opacity and reflection. Practical embodiments of the liner 100 thickness range from 3 to 10 millimeters, with a preferred embodiment being 6 millimeters.

As the thickness of the PTFE layer increases, so do the opacity and reflectivity characteristics of the liner 100. Because the integrating sphere's efficiency for diffusely illuminating a sample substance is related to the diameter of the inner surface, there are occasions in which the liner 100 should not be necessarily manufactured with a thickness of 10 millimeters (i.e., the higher end of the optimum thickness range).

However, if the molded PTFE liner thickness is fabricated at the lower end of the aforementioned optimum thickness range, certain measures may be employed to compensate for the degradation of opacity and reflectivity of the thinner liner. Notably, a highly reflective coating, such as electroplated chrome or spray-on chrome, may be deposited onto the interior surface of the outer articulated hemispherical shell 150 in which the liner 100 will reside. This deposited coating would serve as a reflective “backing” for the PTFE liner 100.

Although this application primarily describes the use of PTFE, it is understood that other polymers may be adapted to function as a substitute to PTFE. Specifically, polychlorotrifluoroethylene, polychlorofluoroethylene, polyvinylidene fluoride, polyvinyl fluoride, and the like may also be utilized for manufacturing the present invention.

While the foregoing is directed to illustrative embodiments of the present invention, other and further embodiments of the invention may be devised without departing from the basic scope thereof, and the scope thereof is determined by the claims that follow.

1. An integrating sphere for a measuring device comprising:
a generally spherical shell; and
a liner disposed within said generally spherical shell, where said liner is composed of a sintered polymer.

2. The integrating sphere of claim 1, wherein said liner comprises a pre-formed polytetrafluoroethylene (PTFE) lining.

3. The integrating sphere of claim 1, wherein said polymer is polytetrafluoroethylene (PTFE).

4. The integrating sphere of claim 1, wherein said liner comprises two generally hemispherical portions.

5. The integrating sphere of claim 1, wherein said generally spherical shell comprises two generally hemispherical portions.

6. The integrating sphere of claim 5, wherein said liner is either molded or sintered into said two generally hemispherical portions that fit into the inside diameter of said generally spherical shell.

7. The integrating sphere of claim 1, wherein said liner comprises a plurality of inclusions.

8. The integrating sphere of claim 7, wherein said inclusions comprise of air.

9. The integrating sphere of claim 8, wherein each of said plurality of inclusions has a diameter ranging from 5 to 20 microns.

10. The integrating sphere of claim 9, wherein said each of said plurality of inclusions has a diameter of 10 microns.

11. The integrating sphere of claim 7, wherein said plurality of inclusions comprises glass beads.

12. The integrating sphere of claim 7, wherein said plurality of inclusions comprises barium sulfate.

13. The integrating sphere of claim 1, wherein thickness of said liner ranges from 3 to 10 millimeters.

14. The integrating sphere of claim 13, wherein opacity and reflectivity of said liner may be improved by depositing a reflective coating onto interior surface of said generally spherical shell.

15. The integrating sphere of claim 14, wherein said reflective coating comprises at least one of: electroplated chrome and spray-on chrome.

16. The integrating sphere of claim 1, wherein said measuring device comprises a spectrophotometer.

17. The integrating sphere of claim 1, wherein thickness of said liner provides sufficient opacity and reflection.

18. An integrating sphere for a spectrophotometer comprising:
a generally spherical shell; and
a liner disposed within said generally spherical shell, where said liner is composed of sintered polytetrafluoroethylene (PTFE).

19. The integrating sphere of claim 18, wherein said liner comprises two generally hemispherical portions.

20. An integrating sphere for a spectrophotometer comprising:
a generally spherical shell; and
a liner disposed within said generally spherical shell, where said liner is composed of compacted polytetrafluoroethylene (PTFE).
